(19) United States
(12) Patent Application Publication
(10) Pub. No.: US 2015/0347358 A1
(43) Pub. Date: Dec. 3, 2015

(54) CONCURRENT DISPLAY OF WEBPAGE ICON CATEGORIES IN CONTENT BROWSER

(71) Applicant: Apple Inc., Cupertino, CA (US)

(72) Inventors: Conrad A. Shultz, San Jose, CA (US); Kevin W. Decker, Los altos, CA (US)

(21) Appl. No.: 14/550,692

(22) Filed: Nov. 21, 2014

Related U.S. Application Data
(60) Provisional application No. 62/006,216, filed on Jun. 1, 2014.

(51) Int. Cl. G06F 17/22; H04L 29/08; G06F 3/0481

(52) U.S. Cl. CPC G06F 17/2247; G06F 3/04817; H04L 67/02

(57) ABSTRACT

Embodiments of processes and systems relate to browser-based enhancements, including a user interface that is configured for concurrently displaying two different categories of webpages for a user, and their corresponding icons. A first icons area has icons representing a first category of webpages based on the browser activity of the user and a second icons areas has non-duplicate icons representing webpages in a second category of webpages selected in response to a user designation. A control allows for replacing the second plurality of icons with a third plurality of icons based on a frequency and recency algorithm for the browser activity.

### CROSS REFERENCE TO RELATED APPLICATIONS

This application claims the benefit of U.S. Provisional Application No. 62/006,216, filed Jun. 1, 2014, entitled “Improvements to Content Browser”, which is incorporated by reference in its entirety.

### TECHNICAL FIELD

This relates generally to browser-based enhancements and sharing saved websites between mobile and non-mobile formatted devices.

### BACKGROUND

In a conventional user interface of a web browsing application, a user may find a previously visited page of interest by means of a history menu—which chronologically lists all the previous pages visited during a recent time interval—or via a bookmarks or favorites menu if the user had the foresight to explicitly store the page in such a retrievable menu. Also, web browsers today often to offer snapshots (webpage previews).

In the case of the history menu, the user has o remember the title or URL of the particular page in order to select it from, or locate it via search in, the oftentimes cluttered menu. Alternatively, a page can be retrieved from bookmarks or favorites menu if the URL was saved previously. Bookmark menus can also require more time than necessary since these menus tend to become cluttered with time as the user adds to the collection of pages and often lack structure. Conventional browsers allow the user to create hierarchical folders within which to organize and display the bookmarks or favorites, but this operation typically is a mostly manual process that can involve sever steps, and in some cases must be done by hand for every bookmark.

### SUMMARY

Described herein are processes related to various browser-based enhancements according to various embodiments. First, a user interface is configured for concurrently displaying two different categories of websites for a user, and their corresponding icons. Second, a method allows for retrieving and rendering touch icons on non-touch enabled devices. Third, a method of sharing favorite websites between mobile and non-mobile formatted devices such that the mobile devices display only mobile-formatted favorite pages.

According to the first aspect, a native view or webpage is displayed in a browser in response to opening a new tab or window, or in response to an explicit user request, where the native view or webpage includes a first icons area, a concurrently displayed and visually distinguished second icons area, and a user interface control element. A first plurality of icons are displayed in the first icons area, each of the first plurality of icons representing a webpage in a first category of webpages for a user of the browser that for the first category are based on browser activity. Icons that represent webpages in a second category of webpages for the user that are non-duplicates of the webpages in the first category of webpages arc identified. A webpage is included in the second category in response to a user designation. The non-duplicates of the second plurality of icons are concurrently displayed in the second icons area. The control element, when selected in some embodiments, causes the browser to replace the second plurality of icons in the second icons area with a third plurality of icons each representing a webpage in a third category based on a frequency and recency algorithm for browser activity. The third set of icons also is checked to only display non-duplicates, and replaces the second set of icons in the second icons area. The control element, when selected in another embodiment, causes the browser to replace the first and second plurality of icons in first and second icons areas with a third plurality of icons each representing a webpage in the third category. The second aspect beneficially enhances the operation of a non-touch enabled device, which receives a webpage for rendering for display on the device. A webpage is examined to determine whether it contains markup language indicative of a touch icon, which is a specialized icon designed for display on touch-enabled device. If the webpage has the touch icon markup language, the touch icon is retrieved and rendered for display on the non-touch enabled device. Otherwise, a request is sent for the same webpage, with a request header identifying the sending device as a touch-enabled device. In return, if the page header includes the touch icon markup, it is retrieved and rendered by the device. Alternatively, if a favicon of a suitable size is available for the webpage, it may be used instead to save power and time. If not, a default touch icon can be used instead, with or without a key color overlaid.

For the third aspect, a first URL for a webpage saved as a first favorite webpage URL on a device is reported to a different device, with the two devices both being linked to a user account. The first URL is replicated on he first device, which has a different forma The URL and/or its webpage is examined to determine whether it comprises one or more characteristics indicative of mobile-formatted webpages, and if so, a second, non-mobile formatted URL for the webpage is saved. The determination includes determining a score for the possible mobile webpage and comparison to a threshold score. The second URL is saved with the first URL for the webpage.

### BRIEF DESCRIPTION OF THE DRAWINGS

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5 is an entity diagram corresponding to entities involved in the methods described in FIGS. 7, 10, and 11 in accordance with some embodiments.

FIG. 6 depicts an exemplary browser in accordance with some embodiments

FIG. 7 is a flowchart for a method of concurrently displaying icons representing two categories of webpages to a user in accordance with some embodiments.

FIGS. 8A-10 show example user interfaces corresponding to the method of FIG. 7 in accordance with some embodiments.

FIG. 11 is an interaction diagram showing a method of rendering touch icons on non-touch enabled devices in accordance with some embodiments.

FIG. 12 is a flowchart for a method of sharing favorite webpages between mobile and non-mobile formatted devices, with reference to FIG. 5 in accordance with some embodiments.

### DETAILED DESCRIPTION

### Exemplary Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are no same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if a stated condition or event is detected” is, optionally, construed to mean “upon determining” or “in response to determining” or “upon detecting the stated condition or event” or “in response to detecting the stated condition or event,” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, Calif. Other portable electronic devices, such as laptops or tablet computers with touch-sensitive surfaces (e.g., touch screen displays and/or touch pads), are, optionally, used. It should also be understood that, in some embodiments, the device is not a portable communications device, beat is a desktop computer with a touch. sensitive surface (e.g., a touch screen display and/or a touch pad).

In the discussion that follows, as electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

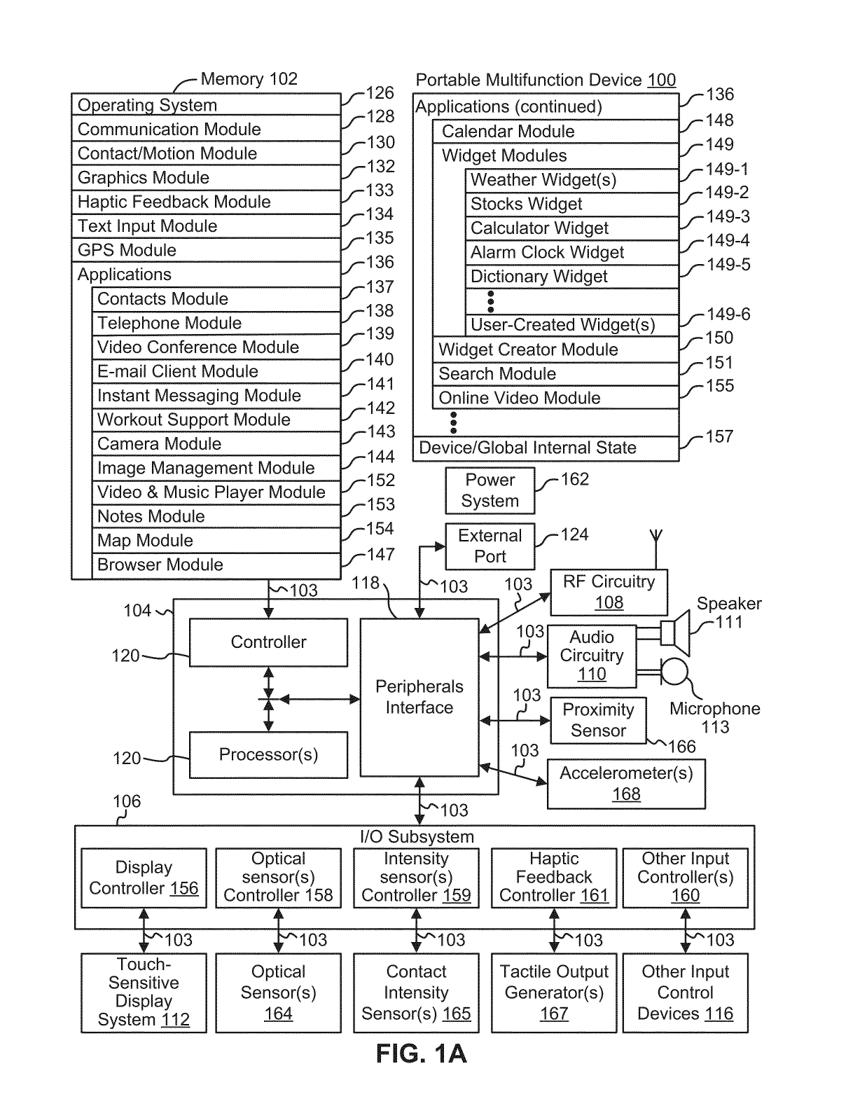

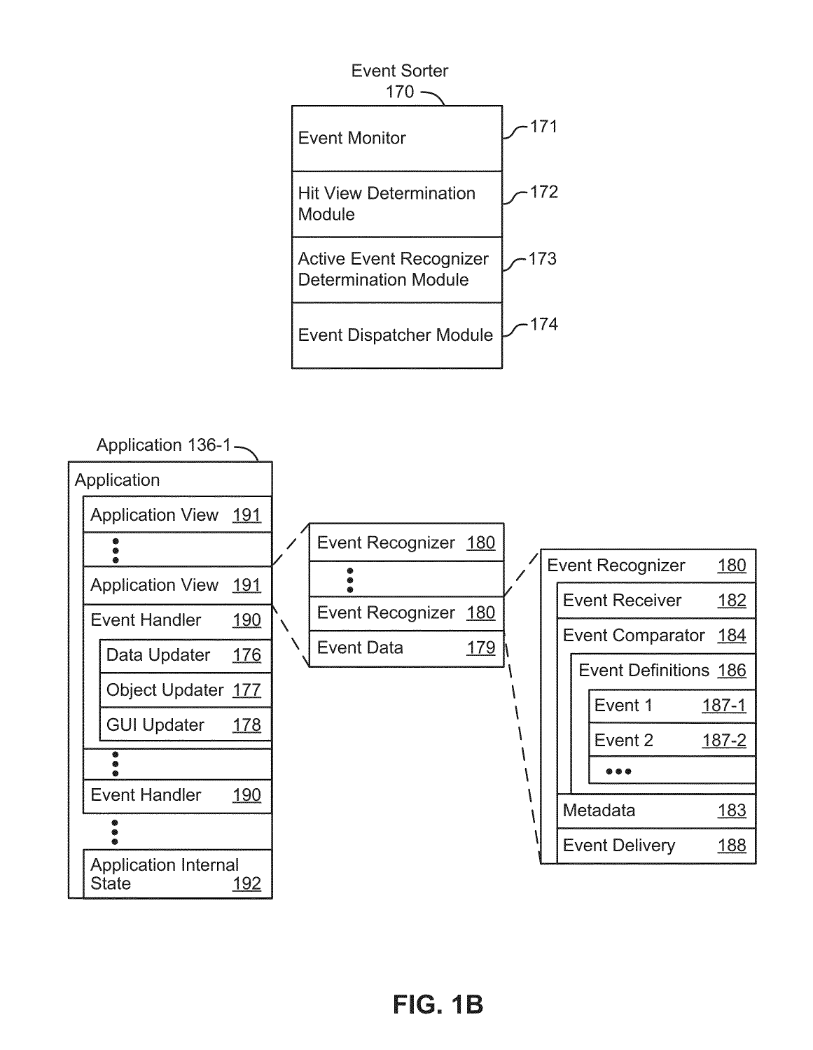

Attention is now directed toward embodiments of portable devices with touch-sensitive displays. FIG. 1A is a block diagram illustrating portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensity of contacts on device 100 (e.g., a touch sensitive surface such as touch-sensitive display system 112 of device 100). Device 100 optionally includes one or more tactile output generators 167 for generating tactile outputs on device 100 (e.g., generating tactile outputs on a touch-sensitive surface such as touch sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch sensitive surface, or to a substitute (proxy) for the force or pressure of a contact on the touch sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure sensitive tip of a stylus is, optionally, used to determine a pressure of the stylus on the touch-sensitive surface. Alternatively, the size of the contact area detected on the touch sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, eluding one or more signal process and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU 120 and the peripherals interface 118, is, optionally, controlled by memory controller 122.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual Cell HSPA DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.1 la, IEEE 8011 lb, IEEE 802.1lg and/or IEEE 802.1 ln).

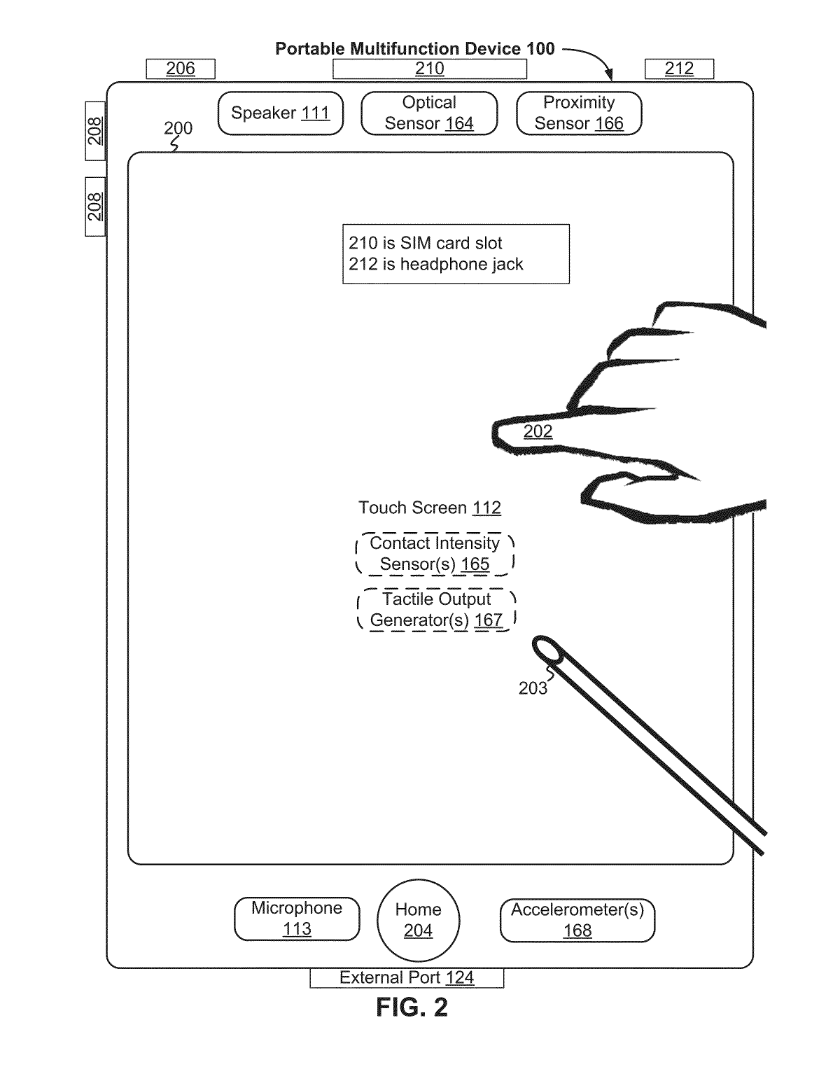

Audio circuitry 110 speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port. USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and converts the detected contact into interaction with user-interface objects (e.g., one or more soft keys, icons, webpages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc, of Cupertino, Calif.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of touch-sensitive surface formed by the touch screen.

Device 100 also includes power system 162 for powering the various components Power system 162 optionally includes a power management system one or more power sources (e.g., battery, alternating current (AC)), a recharging system, a power failure detection circuit, a power converter or inverter, a power status indicator (e.g., a light emitting diode (LED)) and any other components associated with the (generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lens, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device, so that the touch screen display is enabled for use as a viewfinder for still and/or video image acquisition. In some embodiments, another optical sensor is located on the front of the device so that the user's image is, optionally, obtained for videoconferencing while the user views the other video conference participants on the touch screen display.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is coupled to input controller 160 in I/O subsystem 106. In some embodiments, the proximity sensor turns off and disables ouch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

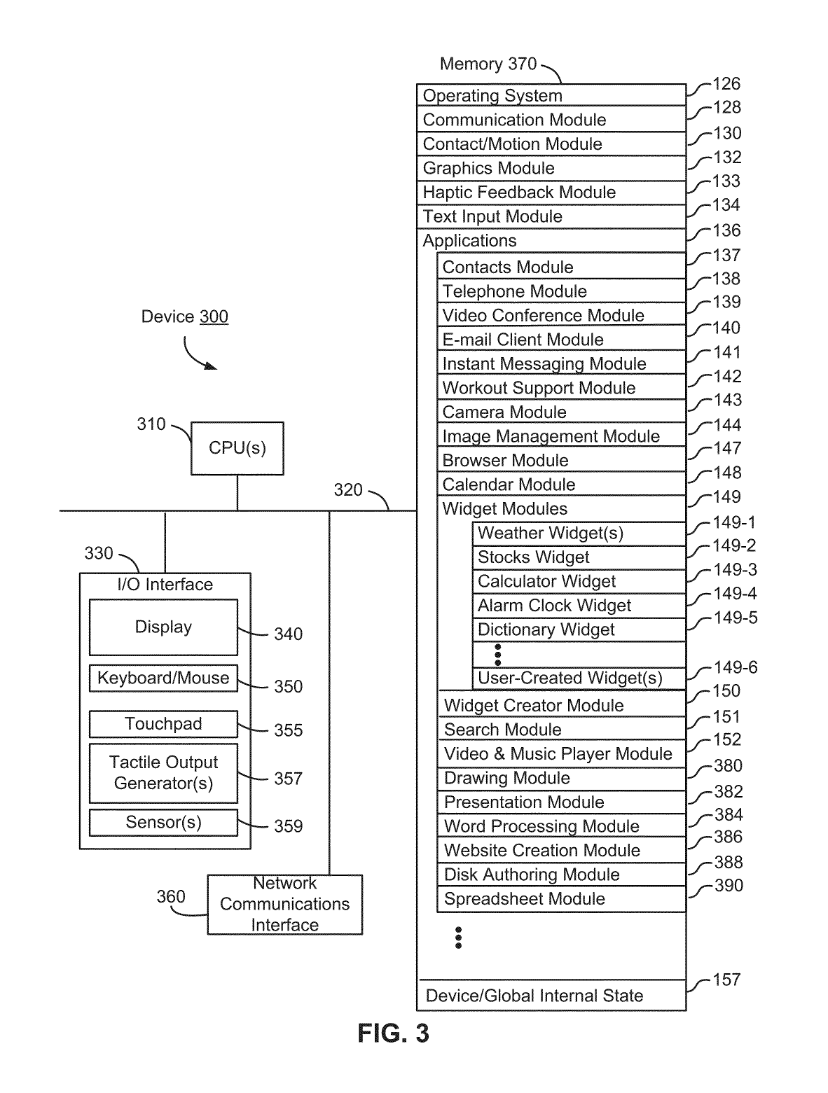

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (OPS) module (or set of instructions) 135, and applications (or sets of instructions) 136. Furthermore, in some embodiments memory 102 stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received b RF circuitry 108 and/or external port 124. External port 124 (e.g., Universal Serial Bus (USB), FIREWIRE, etc.) is adapted for coupling directly to other devices or indirectly over a network (e.g., the Internet, fireless LAN, etc.). In some embodiments, the external port is a multi-pin (e.g., 30-pin) connector that is the same as, or similar to and/or compatible with the 30-pin connector eased on iPod (trademark of Apple Inc.) devices.

Contact/motion module 130 optionally detects contact with touch screen 112 (in conjunction with display controller 156) and other touch sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined thresholds values without changing the trackpad or touch screen display hardware. Additionally, in some implementations a user of the device is provided with software settings for adjusting one or more of the se of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different con act patterns (e.g., different motions, timings, and/or intensities of detected contacts). Thus, a gesture is, optionally, detected by detecting a particular contact pattern. For example, detecting finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event.

Graphics module 132 includes various known software components for rendering and displaying graphics on touch screen 112 or other display, including components for changing the visual impact brightness, transparency, saturation, contrast or other visual property) of graphics that are displayed. As used herein, the term “graphics” includes any object that can be displayed to a user, including without limitation text, webpages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 110, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4 dictionary widget 149-5, and other widgets obtained by the user, as well as user created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e mail address(es), physical address(es) or the information with a name; associating an image with a name; categorizing and sorting names; providing telephone numbers or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch screen 112, display controller 156, contact module 130, graphics module 132, and text input module 134, telephone module 138 are, optionally, used to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch screen 112, display controller 156, optical sensor 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch screen 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

to conjunction with RF circuitry 108, touch screen 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages. In some embodiments, transmitted and/or received instant messages optionally include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact module 130, graphics module 132, text input module 134, UPS module 135, map module 154, and music player module 146, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store and transmit workout data.

In conjunction with touch screen 112 display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact module 130, graphics module 132, text input module 134, and camera module 143, image management module 144 includes executable instructions to arrange, modify (e.g., edit), or otherwise manipulate, label, dele(e, present (e.g., in a digital slide show or album), and store still and/or video images.

In conjunction with RE circuitry 108, touch screen 112, display system controller 156, contact module 130, graphics module 132, and text input module 134, browser module 147 includes executable instructions to browse the Internet in accordance with user instructions, including searching, linking to, receiving, and displaying webpages or portions thereof, as well as attachments and other files linked to webpages.

In conjunction with RE circuitry 108, touch screen 112, display system controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch screen 112, display system controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display system controller 156, contact module 130, graphics module 132, text input module 134, and browser module 147, the widget creator module 150 are, optionally, used by a user to create widgets (e.g., turning a user-specified portion of a webpage into a widget).

In conjunction with touch screen 112, display system controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display system controller 156, contact module 130, graphics module 132, audio circuitry 110, speaker 111, RF circuitry 108, and browser module 147, video and music player module 152 includes executable instructions that allow the user to download and play back recorded music d other sound files stored in one or more file formats, such as MP3 or AAC files, and executable instructions to display, present or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact module 130, graphics module 132, and text input module 134, notes module 153 includes executable instructions to create and manage notes, to do lists, and the like in accordance with user instructions.

In conjunction with RE circuitry 108, touch screen 112, display system controller 156, contact module 130, graphics module 132, text input module 134, GPS module 135, and browser module 147, map module 154 are, optionally, used to receive, display, modify, and store maps and data associated with maps (e.g., driving directions; data on stores and other points of interest at or near a particular location; and other location based data) in accordance with user instructions.

In conjunction with touch screen 112, display system controller 156, contact module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed dust through a touch screen and/or a touchpad. By using a touch screen and/or a touchpad as the primary input control device for operation of device 100, the number of physical input control devices (such as push buttons, dials, and the like) of device 100 is, optionally, reduced.

The predefined set of functions that are performed exclusively through a touch screen and/or a touchpad optionally include navigation between interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (in FIG. 1A) or 370 (FIG. 3) includes event sorter 170 (e.g., in operating system 126) and a respective application 136-1 any of the aforementioned applications 137-13, 155, 380-390).

Event sorter 170 receives event information and determines the application 136-1 and application view 191 of application 136-1 to which to deliver the event information. Event sorter 170 includes event monitor 171 and event dispatcher module 171. In some embodiments, application 136-1 includes application internal state 192, which indicates the current application view(s) displayed on touch sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active even recognizer determination module 173.

Hit view determination module 172 provides software procedures for determining where a sub-event has taken place within one or more views, when touch sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (i.e., the first sub-event in the sequence of sub-events that form an event or potential event). Once the hit view is identified by the hit view determination module, the hit view typically receives all sub-events related to the same touch or input source for which it was identified as the hit view.

Active event recognized determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizes determination module 173, event dispatcher module 174 delivers the event information to an event recognizer determined by active event recognizer determination module 173. In some embodiments, event dispatcher module 174 stores an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or snore event recognizers 180. Typically, a respective application vie 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handle 190 optionally utilizes or calls data updater 176, object updater 177 or GUI updater 178 to update the e application internal state 192. Alternatively, one or more of the application views 191 includes one or more respective event handlers 190. Also, in some embodiments, one or more of data updater 176, object updater 177, and GUI updater 178 are included in a respective application view 191.

A respective vent recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch sensitive display 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handier 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after-which it disregards subsequent sub-events of the touch-based gesture. In this situation, other event recognizers, if any, that remain active for the hit view continue to track and process sub events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event reconizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-even s or with actively involved views receive the event information and perform a predetermined process.

In some embodiments, data updater 176 creates and updates data used in application 136-1. For example, data updater 176 updates the telephone number used in contacts module 137, or stores a video file used in video player module 145. In some embodiments, object updater 177 creates and updates objects used in application 136-1. For example, object updater 176 creates a new user-interface object or updates the position of a user-interface object. GUI updater 178 updates the GUI. For example, GUI updater 178 prepares display information and sends it to graphics module 132 for display on a touch sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the FIG.) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a ouch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., s at to tactile output generators) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3 are, optionally, stored in one or more of the previously mentioned memory devices. Each of the above identified modules corresponds to a set of instructions for performing a function described above. The above identified modules or programs (i.e., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces (“UI”) that is, optionally, implemented on portable multifunction device 100.

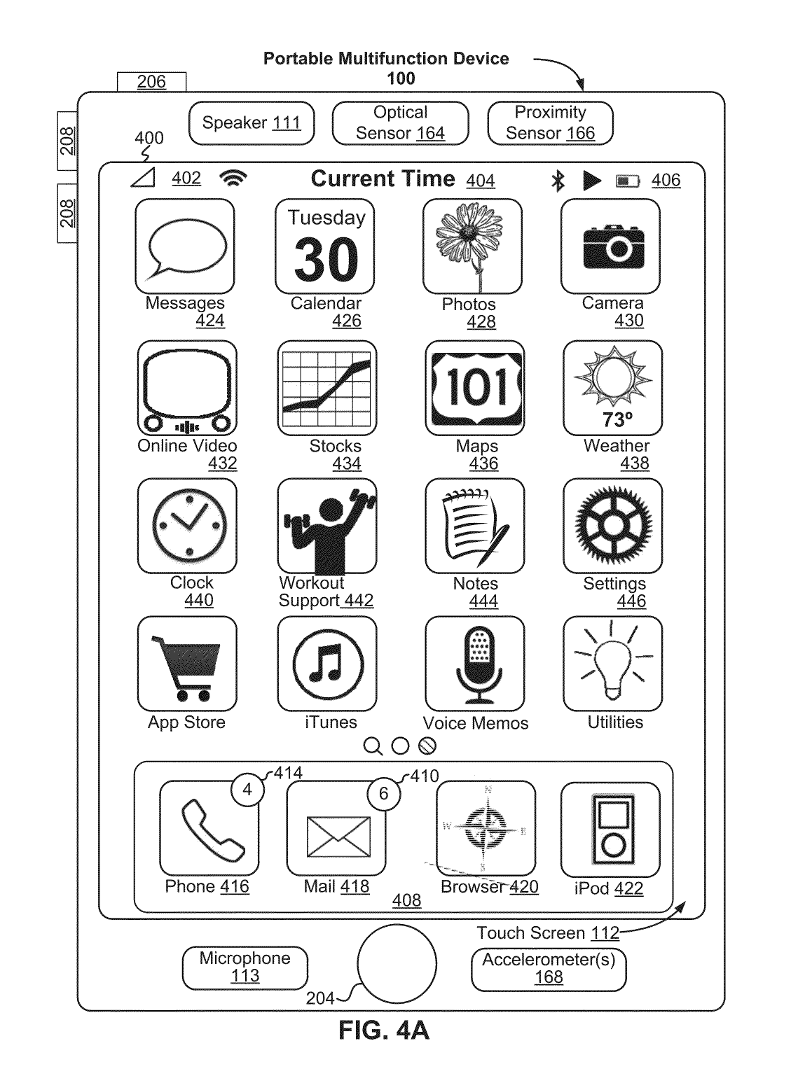

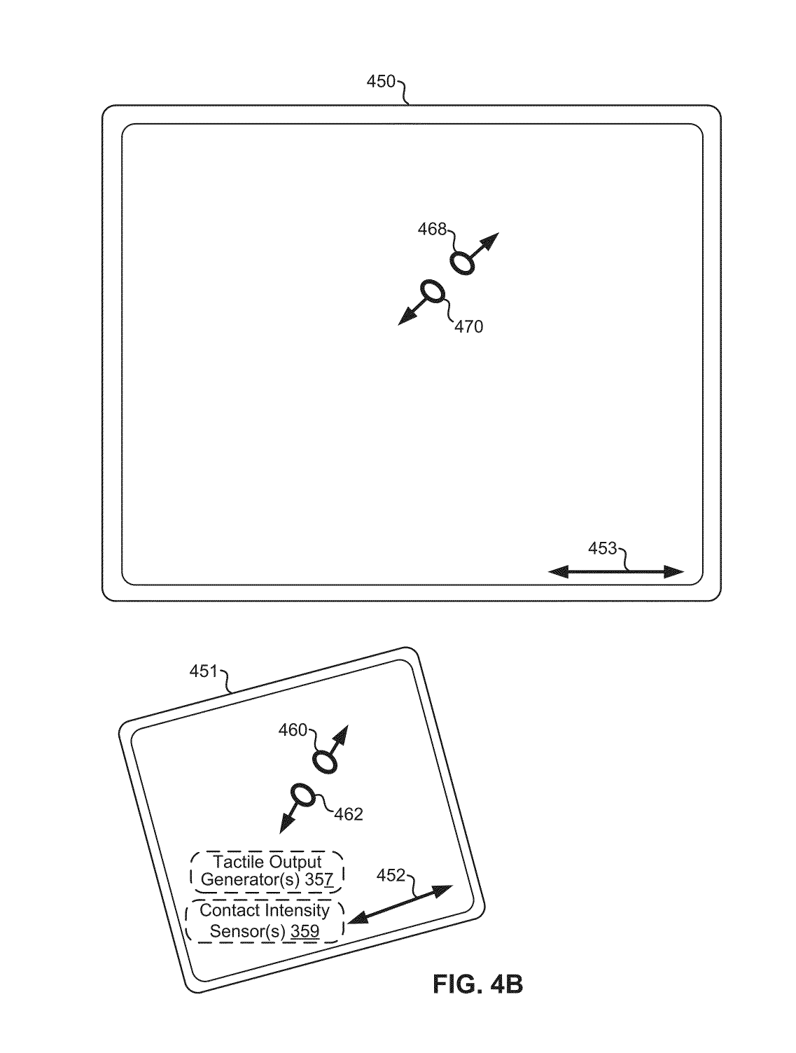

FIG. 4A illustrates an exemplary user interface for a menu of applications on portable multifunction device 100 in accordance with some embodiments. Similar user faces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Text:”
   Icon 426 for calendar module 148, labeled “Calendar:”
   Icon 428 for image management module 144, labeled “Photos;”
   Icon 430 for camera module 143, labeled “Camera;”
   Icon 432 for online video module 155, labeled “Online Video”
   Icon 434 for stocks widget 149-2, labeled “Stocks;”
   Icon 436 for map module 154, labeled “Map;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes” and
   Icon 446 for a settings application or module, which provides access to settings for device 100 and its various applications 136.

It should be noted that the icon labels illustrated in FIG. 4A are merely exemplary. For example, icon 422 for video and music player module 152 are labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding o the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 357) for detecting intensity of contacts on touch-sensitive surface 451 and/or one or more tactile output generators 359 for generating tactile outputs for a user of device 300.

Although some of the examples which follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments the touch sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the (ouch-sensitive surface (e.g., 451 in FIG. 4B) are used by the device to manipulate the user interface on the display (e.g., 150 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch sensitive display system 112 in FIG. 1A or touch screen 112 in FIG. 4A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

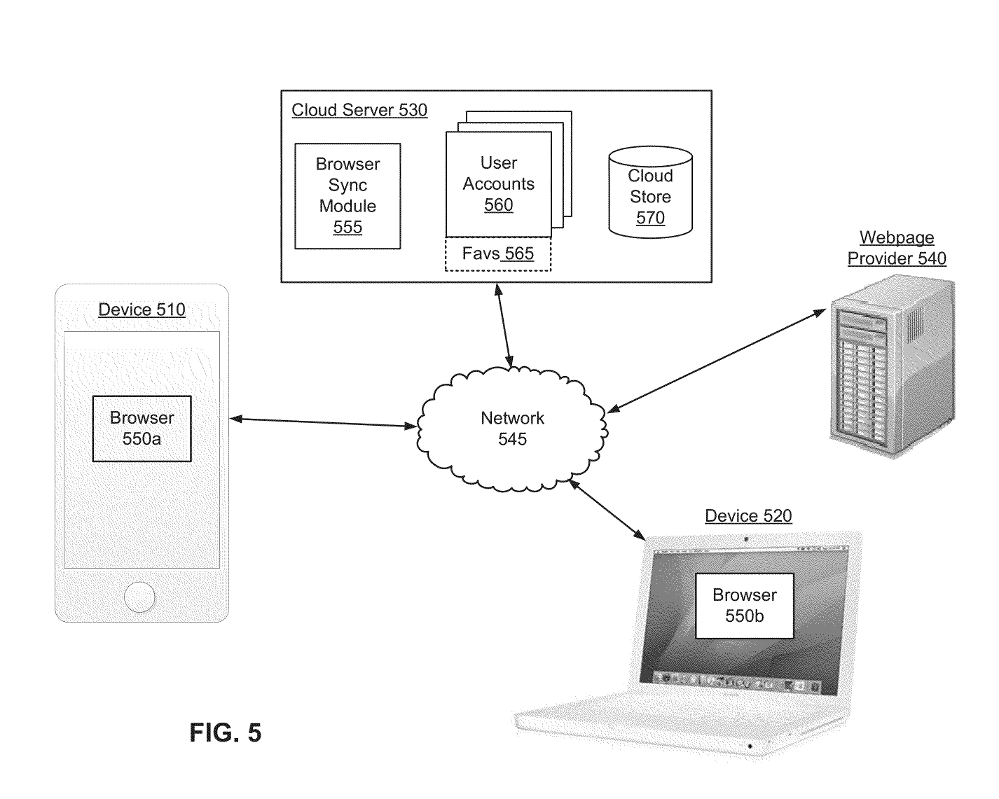

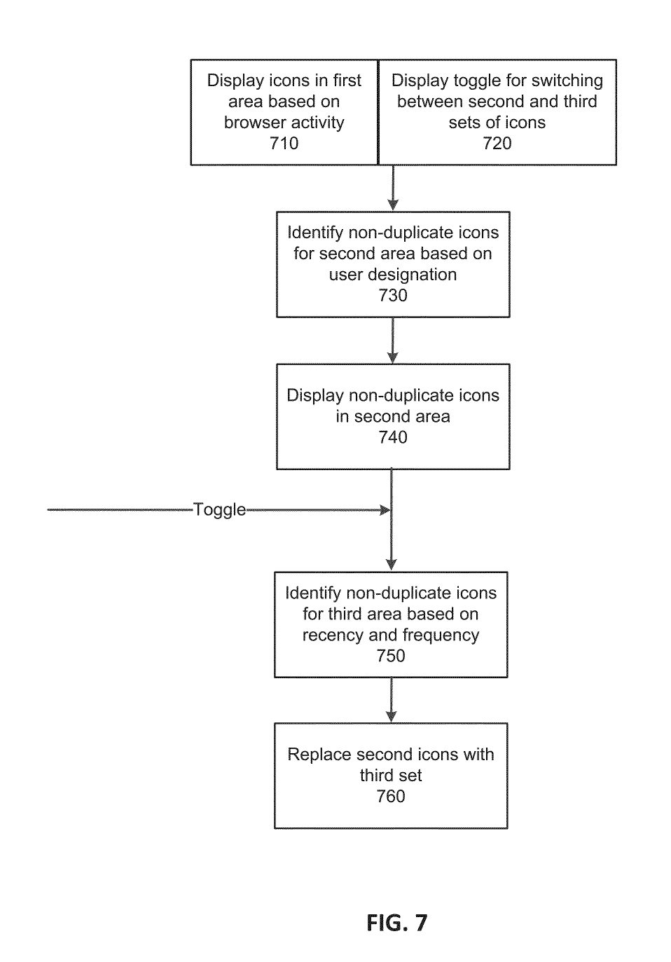

FIG. 5 is an entity diagram corresponding to entities involved in the methods described in FIGS. 7, 10, and 11. FIG. 5 includes devices 510, 520, cloud server 530, and webpage provider 540 connected via a network 545.

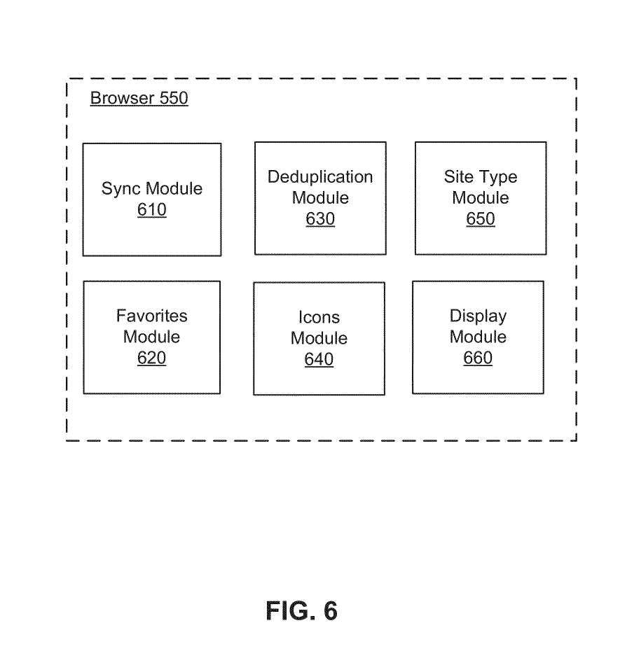

Device 510 in some embodiments is a mobile-formatted, touch-enabled device, such as a smartphone or tablet. Device 520 may be a non-mobile formatted, non-touch enabled device, such as a laptop or desktop computer. Other devices of various types may be used in other embodiments. For example, either of devices 510, 520 may be portable multifunction device 100 or device 300 as described herein. Each of devices 510, 520 include a browser 550, which is described in greater detail in conjunction with FIG. 6.

Cloud server 530 is any computing device or a cloud server, such as Apple, Inc.'s iCloud™, and in some circumstances is a general purpose computer or server-level computer as described in conjunction with FIGS. 1A-4B.

Cloud server 530 includes a browser sync module 555, user accounts 560 (including favorites 565), and cloud store 570.

Browser sync module 555 allows user accounts 560 linking different devices (e.g., 510, 520) to access shared information such as favorites 565, and is one means for performing this function. Because devices 510, 520 are linked to each other via a shared account, e.g., via user accounts 560 of cloud server 520, the shared information is stored in the favorites 565 and synced between the two devices by browser sync module 555 (and corresponding sync module 610 on each of devices 510 and 520).

The cloud store 570 includes a non-transitory computer-readable storage medium, such as a hard drive, compact disk read-only memory (CD-ROM), DVD, or a solid-state memory device. Webpage provider 540 can be any web server or other third party content provider. Network 545 includes in various embodiments any combination of local area and/or wide area networks, using both wired and wireless communication systems.

FIG. 6 shows browser 550. Browser 550 is a web browser application 125, such as Safari® from Apple Inc. or Internet Explorer® from Microsoft Corporation. The browser 550 has multiple modules: sync module 610, history module 620, deduplication module 630, icons module 640, site type module 650, and display module 660. As is known in the art, the term “module” refers to computer program logic utilized to provide the specified functionality to the computing device. Other embodiments can have different and/or other modules than the ones described here, and that the functionalities can be distributed among the modules in a different manner.

History module 620 receives selections of favorite websites and other browser history, and maintains them, and is one means for performing this function. The user's browser activity is maintained by the favorites module, e.g., by identifying and saving it locally on device 510, 520.

Sync module 610 connects the favorites saved locally in the history module 620 with the favorites 565 associated with the user's account 560 at the cloud server, and is one means for performing this function, typically in conjunction with browser sync module 555.

Deduplication module 630 identifies icons corresponding to websites to determine non-duplicates between categories of websites, and is one means for performing this function. Typically the portion of the URL after a trailing slash is ignored for this determination.

Icons module 640 determines whether a page includes touch icon markup language and or touch icons, and is one means for performing this function. The icons module 640 performs this check on webpage content, page headers, or any other page markup to determine whether the page provides information necessary for displaying touch icons, and can initiate updates to check for newer touch icon versions.

Site type module 650 checks sites for characteristics of a mobile-formatted website, and is one means for performing this function. Specifically, it checks for characteristics such as a URL with a mobile prefix (e.g., m.example.com), the website may have a fixed viewport with a width corresponding to a mobile device size class, or a website may display a smart app banner (e.g., display a control for switching to viewing a native application associated with the website).

Display module 660 controls presentation of graphical user interface aspects on the display, for example, for providing the user interfaces described herein. Display module 660 in some embodiments is presentation module 382.

### User Interfaces and Associated Processes

Attention is now directed towards embodiments of user interfaces (“UI”) and associated processes that my be implemented on an electronic device with a display and a touch-sensitive surface, such as device 300 or portable multifunction device 100. Three processes are described herein related to various browser-based enhancements. First, a user interface is described for concurrently displaying two different categories of websites for a user, and their corresponding icons. Second, a method of rendering touch icons on non-touch enabled devices. Third, a method of sharing favorite websites between mobile and non-mobile formatted devices such that the mobile devices display only the mobile-formatted favorite pages.

### User Interface for Displaying Two Different Categories of Websites for a User

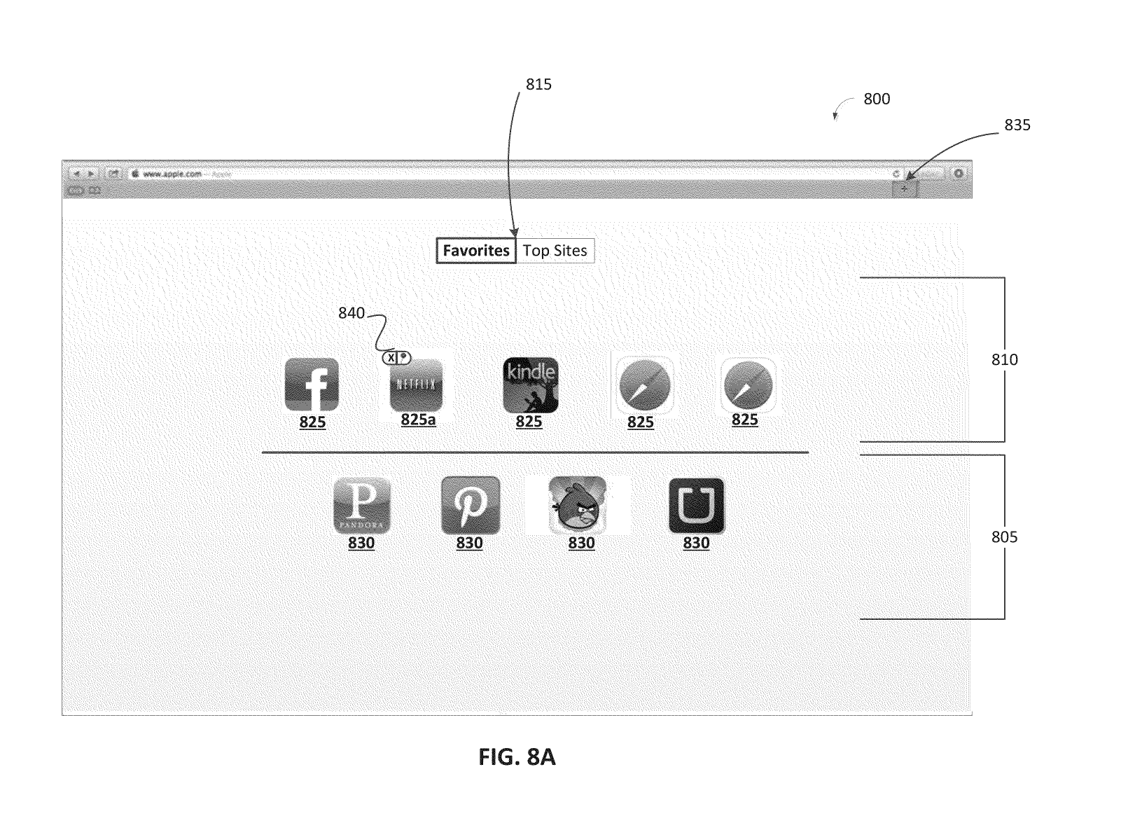

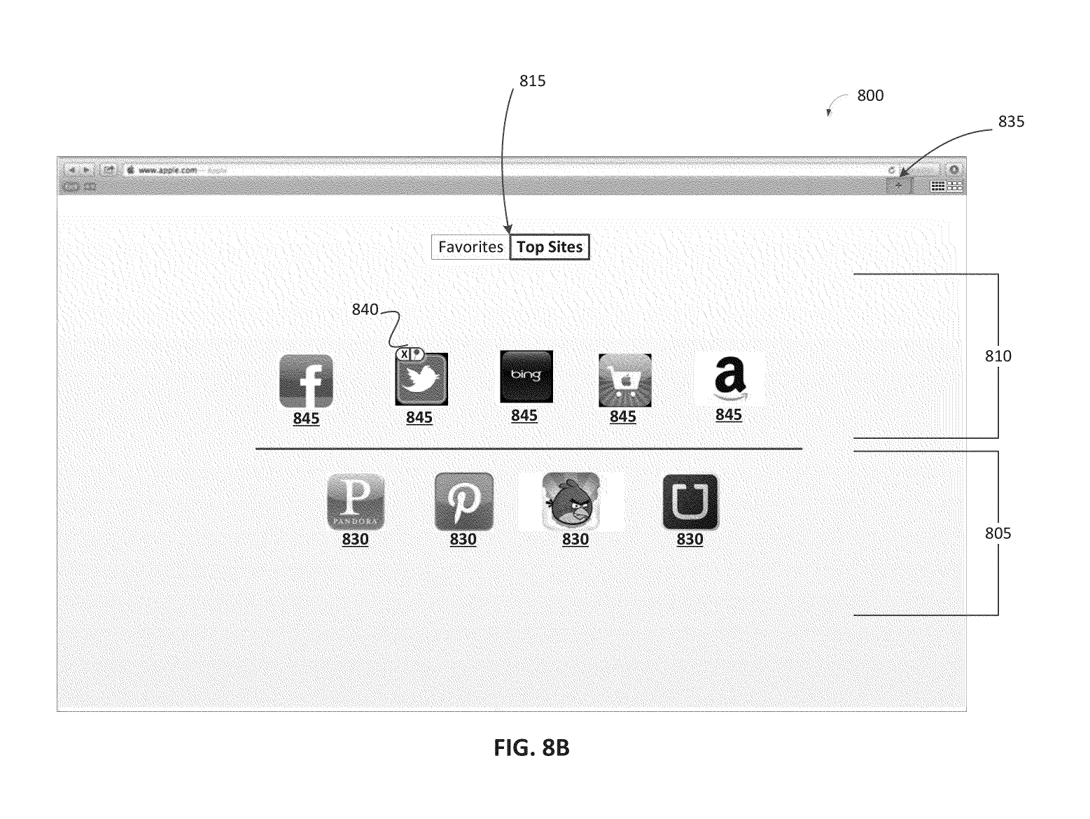

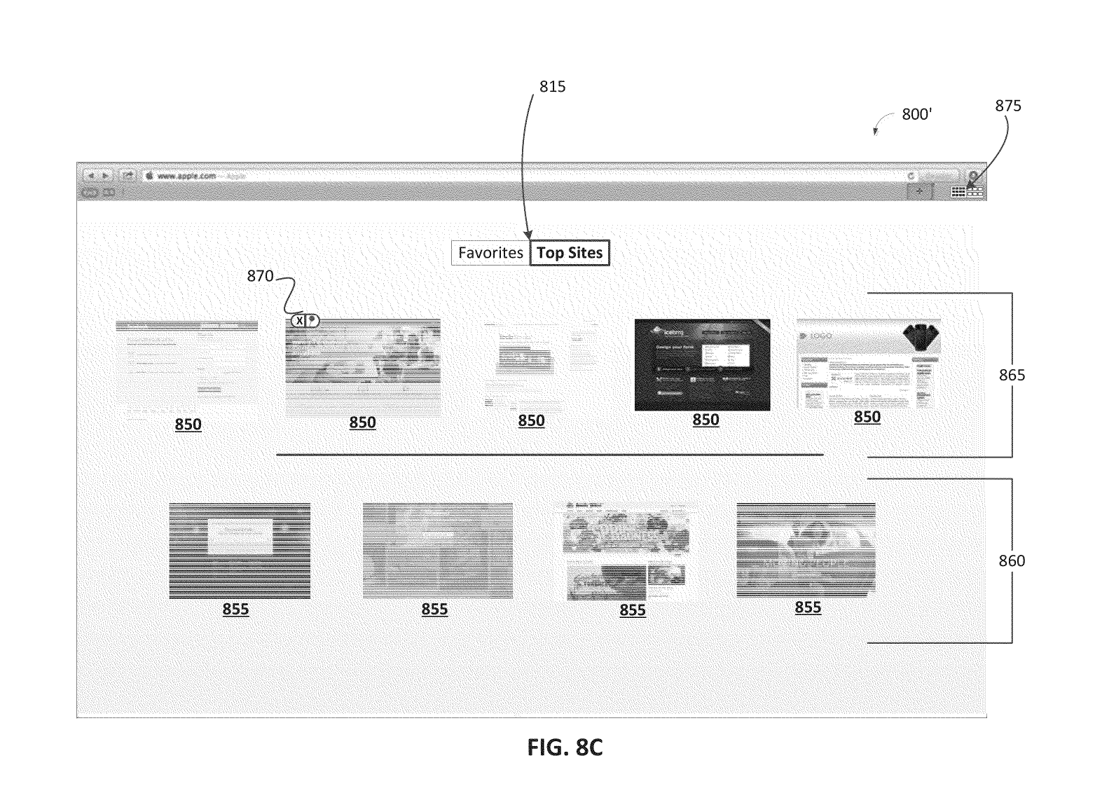

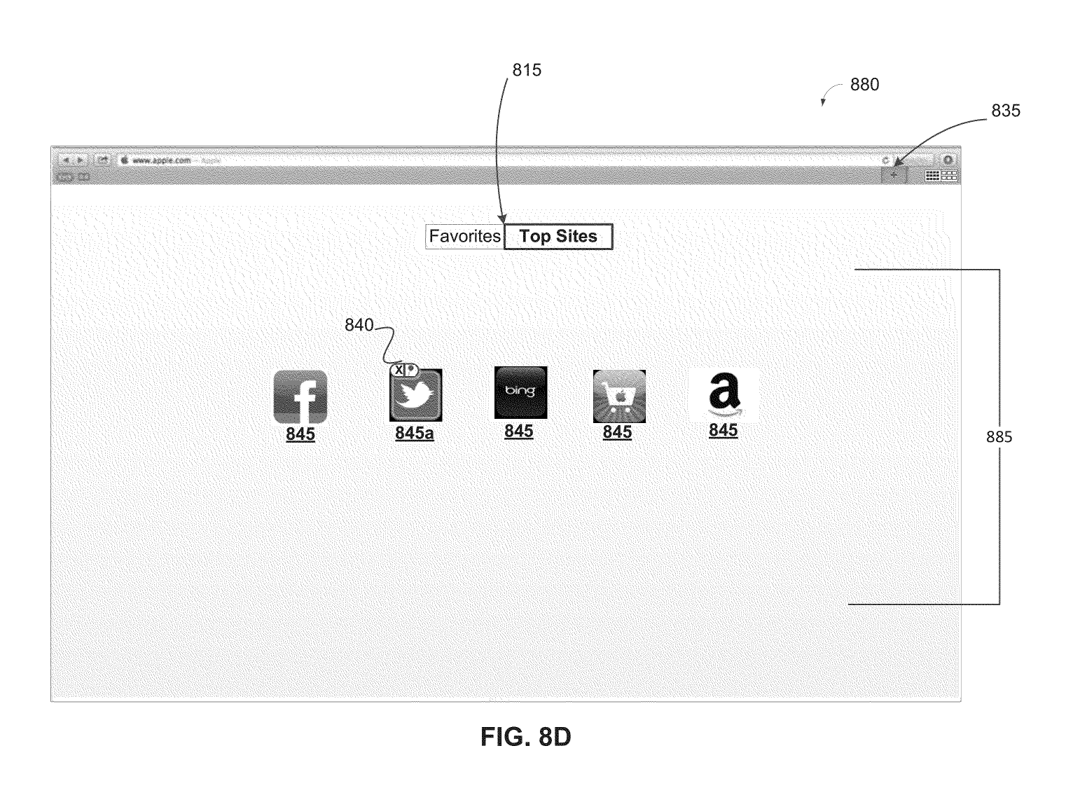

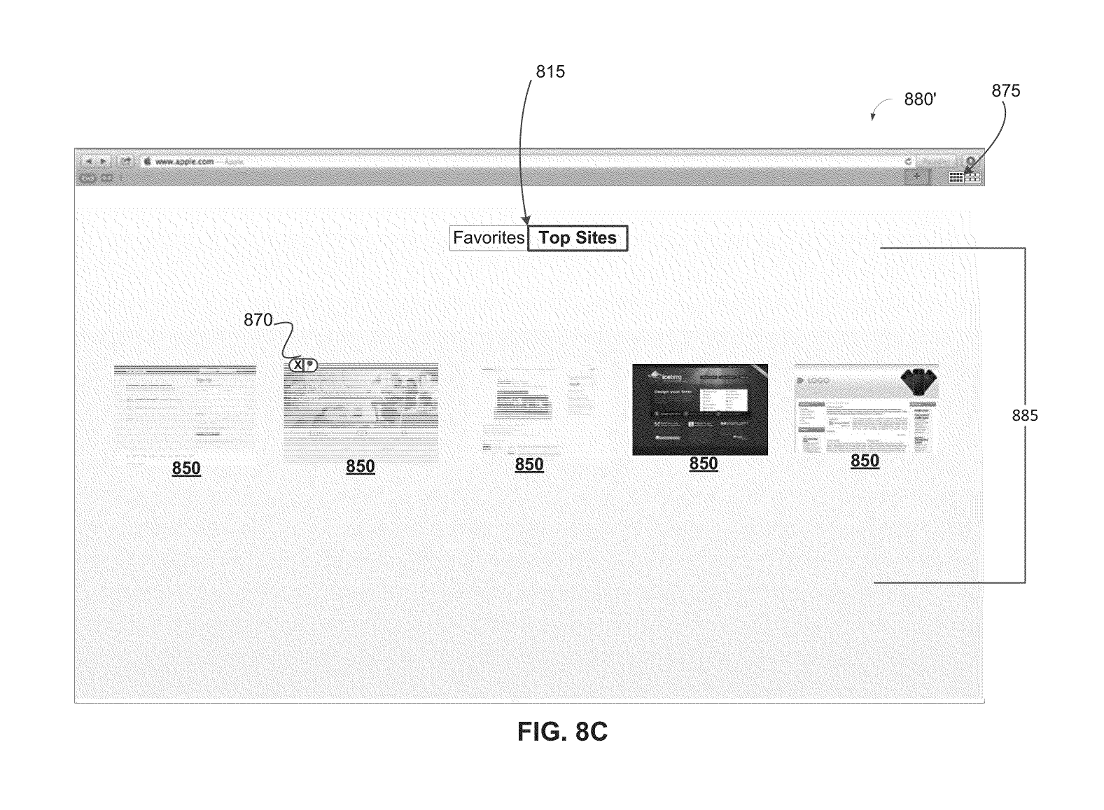

FIG. 7 is a flowchart for a method of concurrently displaying icons representing two categories of websites to a user according to some embodiments. The process is initiated in response to a user opening a new tab or window, or in response to an explicit request such as selecting a menu item, in a browser 550, where the browser 550 displays a view or webpage comprising first and second icons areas, and a UI toggle control (used interchangeably with “control” herein). An example webpage is shown in FIG. 8A, described below. The user interface may be provided, e.g., by a display module 660 on browser 550, by presentation module 382, or by any other means for rendering and displaying the page content to the user in an interface. In some embodiments, first icons displayed 710 in the first icon area each represents a website in a first category of webpages, selected based on the browser activity of the user, e.g., a user's most frequently visited webpages. The user's browser activity is maintained by the browser, e.g., by history module 620, or in local or remote storage. The first icons area may be displayed in a lower region of the view/webpage. A UI toggle element also is displayed 720 that allows UI to switch between categories of content for display in the view/webpage, according to two separate embodiments. In some embodiments in which the UI toggle element toggles a display of the first set of icons and either a second set of icons or third set of icons, before displaying any icons in the second icons area, the state of the UI toggle is determined for whether to display a second set of icons or a third set of icons, each corresponding to a different category of webpages for the user. This embodiment is shown in FIGS. 8A-8C. In another embodiment, in which the UI toggle element toggles between a view including the first and second icons areas or the third set of icons alone, the state of the UI toggle is determined for whether to display two sets of icons, or a third set of icons, each corresponding to a different category of webpages for the user. This embodiment is shown in FIGS. 8A and 8D-8E. In one example, the second category of websites are webpages grouped in response to a user designation, e.g., a user-specified set of “favorite” webpages, and the third category of webpages is determined by a frequency and recency algorithm, also known as the “top sites” for the user. Embodiments of algorithms for determining top sites are described in US2010/0095219, which is incorporated by reference herein, in its entirety.

In the first embodiment in which the toggle is between two categories of webpages in the second icons area, once the category is known for the second icon area, then webpages in that category are identified 730 that are non-duplicates of the webpages in the first category of webpages, and the icons for these webpages are displayed 740 in the second icons area. The de-duplication may be performed, e.g., by de-duplication module 630 of browser 550. Duplicate webpages may be identified based on their URLs, for example based on the host domain. The second icons area may be displayed in an upper region on the view/webpage, if the first icons area is displayed in the lower region of the view/webpage. other words, if a website is included in both the first category of webpages and the second category of webpages, then the corresponding icon is displayed in the first icon display area, but is not duplicated in the second icon area corresponding to the duplicate webpage in the second category. In the second embodiment, in which the toggle is between two categories and single, third category, if the UI toggle has been selected to show two sets of icons, then only webpages in the second category a e identified 730 that are non-duplicates of the webpages in the first category of webpages as above.

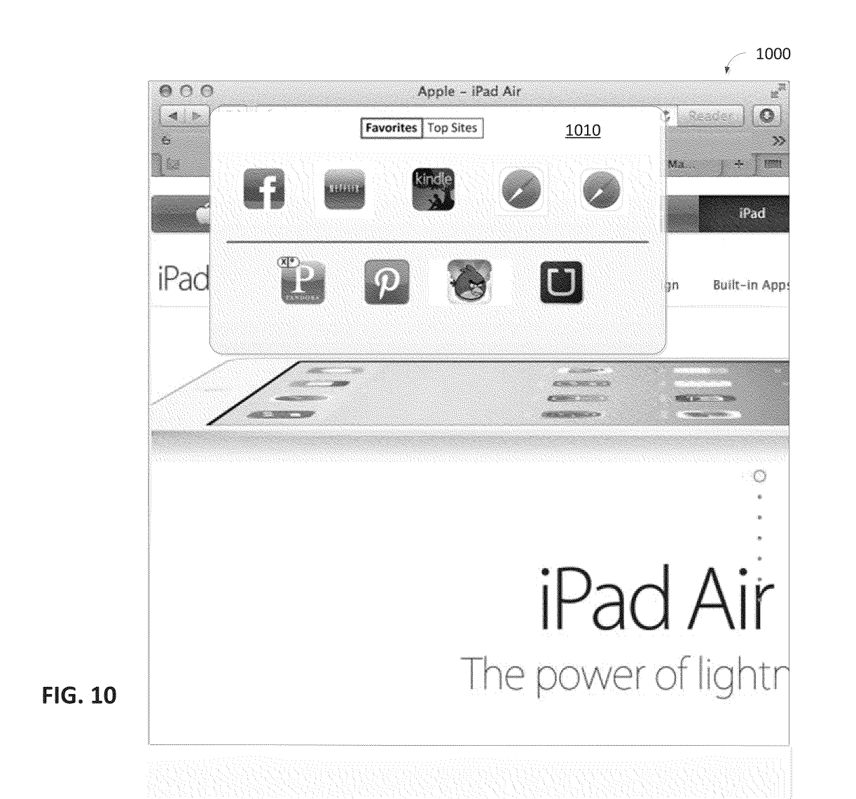

In an alternative embodiment, when the user input is received to open a new tab in a browser, a drop down is displayed with a view displaying a miniaturized or otherwise adapted version of the view/webpage. An example of this drop down is shown in FIG. 10, described further below. In some instances, the miniature version of the webpage has a width equal to a width of a search bar, which changes with the resizing of the webpage.

Next, in the first embodiment, in response to selection of the UI toggle for replacing the second set of icons in the second cons area with the third set of icons, those websites in the third set are identified 750 that are non-duplicates of the websites in the first category of websites, and the corresponding icons are displayed 760 in the second icons area. As above, when the is toggled to display the third set of icons, if a website is included in both the first category of websites and the third category of websites, then the corresponding icon continues to be displayed in the first icon display area, but is not duplicated in the third icon area corresponding to the duplicate website in the third category. Thus, at any given time, the user interface displays icons corresponding to the first category in the first icons area, and icons that are not duplicates of the websites corresponding the first icons area icons for either the second or third categories in the second icons area, subject to the position of the UI toggle.

In the second embodiment, the next step is, in response to selection of the UI toggle for replacing the first two sets of icons with the third set of icons, those websites in the third set are identified 750, and the corresponding icons are displayed 760 in the view/webpage. Thus, at any given time, the user interface displays icons corresponding to the first and second categories in the first and second icons areas, respectively, or icons corresponding the third category, subject to the position of the UI toggle.

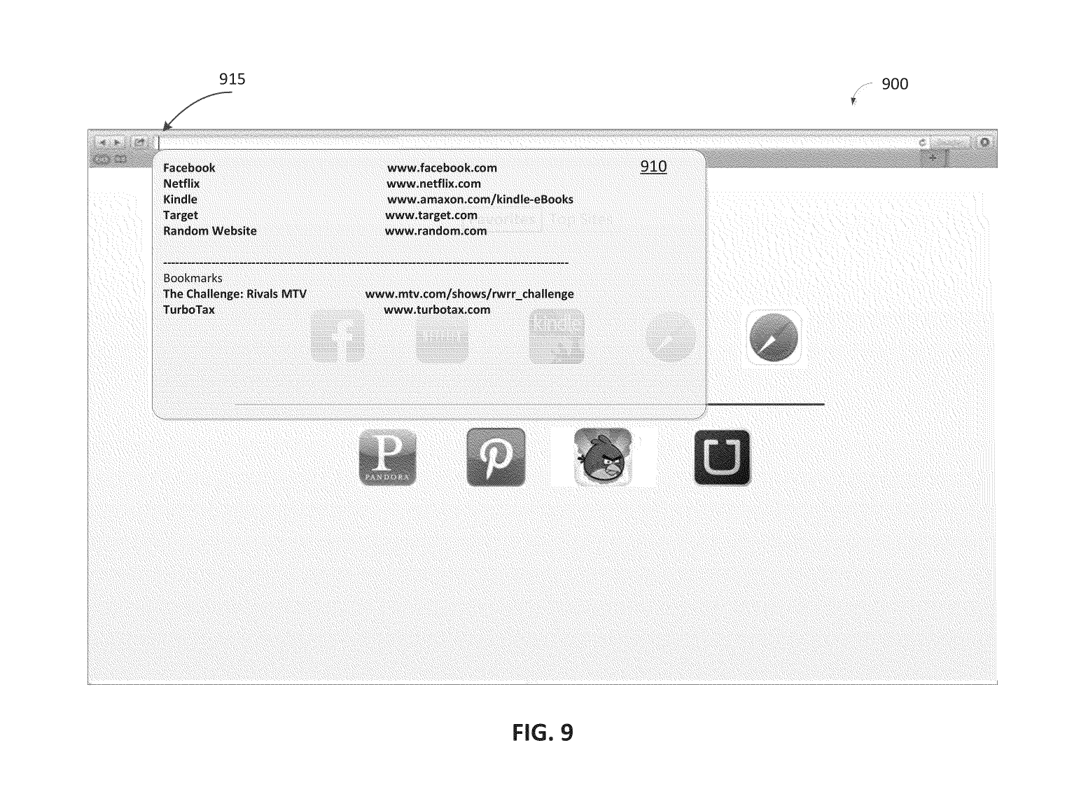

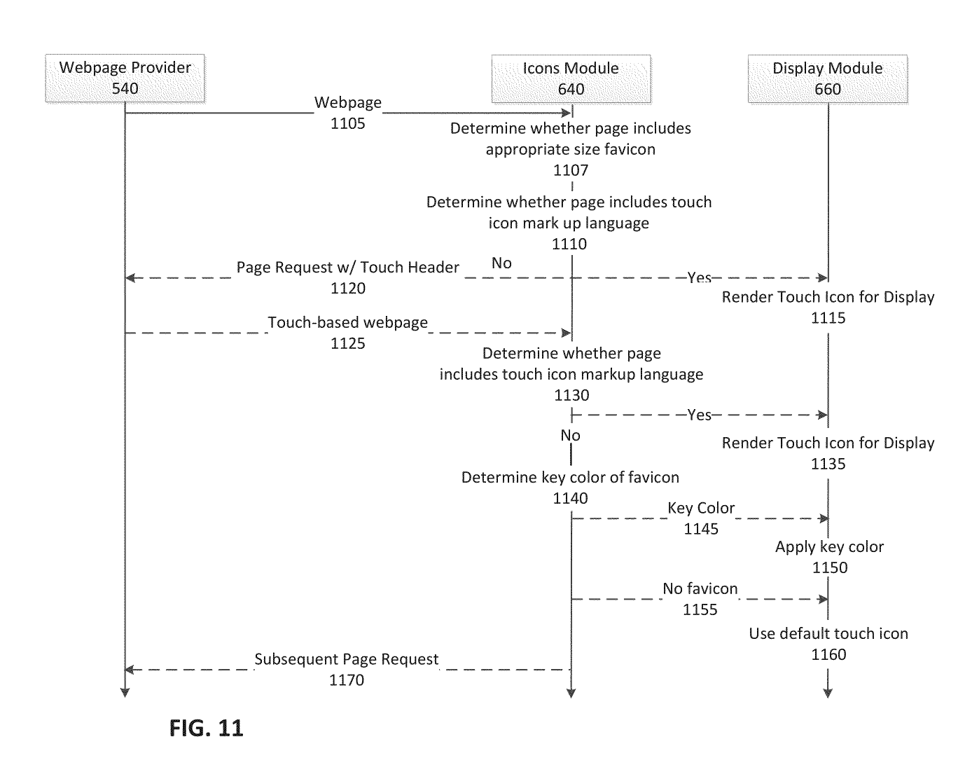

The view/webpage also may include a webpage representation control, which when selected allows the user to switch between the icon view of the webpage and a thumbnail view of the webpage. An example webpage representation control is discussed in conjunction with FIG. 8C below. In response to resizing of the view/webpage, the icons may reflow on the view/webpage in different ways, e.g., with the second plurality of icons reflowing in one manner and the third plurality of icons reflowing in a different manner. The reflow may decrease space between icons, decrease the size of icons, move icons to a next row in constrained widths, and the like. In some embodiments, the icons displayed in the view/webpage are touch icons specialized designed for display on touch-enabled devices even though the device displaying the webpage is not a touch-enabled device. Examples of touch icons are shown in FIG. 8A as icons 825, 830, and touch icons are discussed in greater detail below in conjunction with FIG. 11. In some instances the first category of webpages from a device displaying the view/webpage can be replicated to another device on a shared account. The view/webpage also may allow for display of a drop domain menu in some instances comprising a list of the first category of webpages, e.g., in response to receiving user input changing focus to a search bar of the browser. An example of a drop down list in show in FIG. 9, which is discussed in greater detail below.

FIGS. 8A-10 show example user interfaces corresponding to the method of FIG. 7. FIG. 8A is a user interface 800 for displaying a view/webpage with icons in two different categories of websites according to the first embodiment. The user interface 800 includes a first icons area 805 and a second icons area 810. In this example, the first icons area 805 is displayed in a lower region and the second icons area 810 is displayed in an upper region. The first icons area 805 displays a first set of icons 830 corresponding to a first category of webpages based on browser activity of the user. The user interface 800 also includes a user interface toggle 815, for switching between two sets of icons for display in the second icons region 810, or switching to a view with a third set of icons, according to different embodiments. One set corresponds to a second category of webpages that are user designated into the category, e.g., a selection of favorite webpages. These are icons 825 as shown in FIG. 8A. Another set corresponds to a third category of webpages that are based on a frequency and recency algorithm. This category is shown as “Top Sites” in FIG. 8B, with icons 845. In some embodiments the view/webpage of FIG. 8A is a launch page that is displayed in response to receiving user input to open a new tab or new window, e.g., via control 835.

FIG. 8D is a user interface 880 for displaying a view/webpage with icons in the third category of websites according to the second embodiment. This is the result of toggling UI toggle 815 in the second embodiment, which yields a view with just the third set of icons. The user interface 880 includes just a third icons area 885 with icons 845.

In either embodiment, the view/webpage also allows for a high degree of user curation of the icons displayed. For example, an icon control 840 exists for each icon in the second icons area 810 and third icons area 885, as shown on icon 825a and 845. The icon control 840 includes an X button for removing the icon from the displayed icons, and a pin button for pinning e icon to the displayed icons such that it persists in the display, even if other conditions change. User curation may also include reordering the icons or renaming the titles of the icons, either through mouse gestures (e.g. dragging or long-press), menu actions, or keyboard manipulation.

FIG. 8B displays a slightly modified version of the user interface 800 of FIG. 8A that results from toggling in the first embodiment. As shown, the user interface toggle 815 has been switched to Top Sites, such that the third set of icons 845, corresponding to the third category of websites, is displayed. As with the Favorites UI 800 of FIG. 8A, an icon control 840 is shown in the second icons area 810, allowing manual user removal or pinning of icons 845 that area.

FIG. 8C displays another user interface 800′ for displaying the view/webpage of FIG. 8A/B according to the first embodiment, but showing thumbnails 850, 855 instead of icons in two different categories of webpages. A first thumbnail area 860 replaces the first icons area 805, and a second thumbnail area 865 replaces the second icons area 810 in this example. A thumbnail control 870 is provided for manual user curation (removal, pinning) of the thumbnails 850 in the second thumbnail area 865, similar to the icon control 840 discussed above. A webpage representation control 875 allows the user to toggle between the thumbnail UI 800′ of FIG. 8C and the icon UI 800 of FIG. 8B. According to some embodiments, there is no thumbnail UI corresponding to the display of Favorites icons 825 in FIG. 8A.

FIG. 8E displays another user interface 880′ for displaying the view/webpage of FIG. 8C, but showing thumbnails 850 instead of icons in the third category of webpages according to the second embodiment. A thumbnail control 870 is provided for manual user curation (removal, pinning) of the thumbnails 850, similar to the icon control 840 discussed above. A webpage representation control 875 allows the user to toggle between the thumbnail UI 880′ of FIG. 8E and the icon UI 880 of FIG. 8D.

FIG. 9 shows a UI 900 for a favorites suggestion drop down menu 910. In response to receiving user input changing focus to a search bar 915 of the browser (a cursor is shown in the search/URL field 915), a drop down menu 910 is displayed with a list of the first category of webpages (Favorites) for a user of the browser, which corresponds to the second set of icons 825 from FIG. 8A. The drop down 910 provides another means for the user to easily access their favorite websites. Although the drop down 910 is shown overlaid on the view/webpage with the icons (similar to FIG. 8A), the drop down 910 is accessible from any webpage just by changing cursor focus to the search bar 915 location. Once text beings to be received in the search bar 915, even one character, the drop down menu 910 is no longer displayed.

FIG. 10 shows a UI 1000 with an alternative drop down 1010 menu embodiment. In this example, instead of displaying a list of Favorite websites 825 in the drop down menu 1010, a miniature version of the view/webpage 800 of FIG. 8A ids displayed. The miniature view/webpage drop down 1010 has a width equal to the width of a search bar in some embodiments, and varies with resizing of the webpage window. There may also be a minimum width threshold below which the miniature webpage drop down 1010 will not further reduce in size. The UI toggle may also be excluded from the miniature webpage/view drop down 1010, with one or the other mode permanently displayed.

### Rendering Touch Icons for Display on Non-touch Enabled Devices

FIG. 11 is an interaction diagram showing a method of rendering touch icons on non-touch enabled devices. The method begins with receiving 1105, by a non-touch enabled device, a webpage from a webpage provider 540, e.g., webpage provider 540. As a preliminary step, a check is performed 1107 of whether the webpage includes a favicon of suitable minimum size for display. A favicon, short for favorite icon, is an icon typically associated with a webpage, e.g., a favicon.ico file resource on the web server. However, many favicons are very small, such as 16×16 pixels, and designed for placement within a tab for the webpage in a tabbed interface. Such small favicons are not suitable for use as replacements for touch icons because when enlarged for such use, they appear pixelated or otherwise unappealing. If the webpage does not have a favicon of an appropriate size, the method continues. Ideally, a favicon is at least 152×152 pixels. An appropriate size favicon is at least 72×72 pixels; anything smaller is below the “suitable minimum size” as used herein, and will not be used. An icons module 640 determines 1110 whether the page includes touch icon markup language. A “touch icon,” as used herein, is a specialized icon designed for display on a touch-enabled device. Touch icons are shown in FIG. 8A as icons 825, 830. In response to the page including touch icon markup language, the touch icon is rendered 1115 for display on the non-touch enabled device, e.g., device 520 of FIG. 5. In some embodiments, fixed locations on a website may be searched for touch icons irrespective of markup (e.g. example.com/apple-touch-icon.png). In response to the page not including touch icon markup language, a request for webpage 1105 is transmitted 1120 to the webpage provider, including with the request a header containing a device identifier associated with a touch-enabled device. E.g., a device identifier associated with device 510 would be an identifier for a touch-enabled device. The identifier sent to the webpage provider does not need to be associated with an actual physical device, but can be a virtual identifier associated with a particular device type or size class.

Once the webpage is received 1125, it is again determined 1130 whether the page header includes touch icon markup language. If it does, the touch icon is rendered 1135 for display on the non-touch enabled device. If the page header does not include touch icon markup language, a key color of the webpage favicon is determined 1140, and the key color is sent 1145 to the display module for application 1150 to a default browser touch icon. Icon 825b is an example of a default icon with a key color applied to it. If no key color can be determined 1155 (e.g., if no favicon is available), the default browser touch icon is used 1160 without any color applied. Icon 825c is an example of a default icon with no key color applied to it. A key color, according to some embodiments, is the most dominant color of the favicon. Method for determining a dominant color of a favicon are known in the art and thus not discussed here in further detail.

In some embodiments, periodic checks may be made for new markup language indicating that the touch icon has changed, e.g. by the icons module 640. There may be one or more subsequent page requests 1170 related to the checks. If they occur, it is determined whether an updated touch icon is available corresponding to the website. A subsequent page request might result from a user accessing the webpage at a later time, a priority for checking the webpages for updates, or other reasons. In some embodiments, new touch icons may be requested if a new version of the markup processing algorithm is deployed. If a priority queue is used for checking for new touch icons, and none is found after several attempts, the browser may implement aback-off algorithm that increases the duration between tried to update the touch icon, and eventually ceases trying.

### Sharing Favorite Websites Between Mobile and Non-mobile Formatted Devices

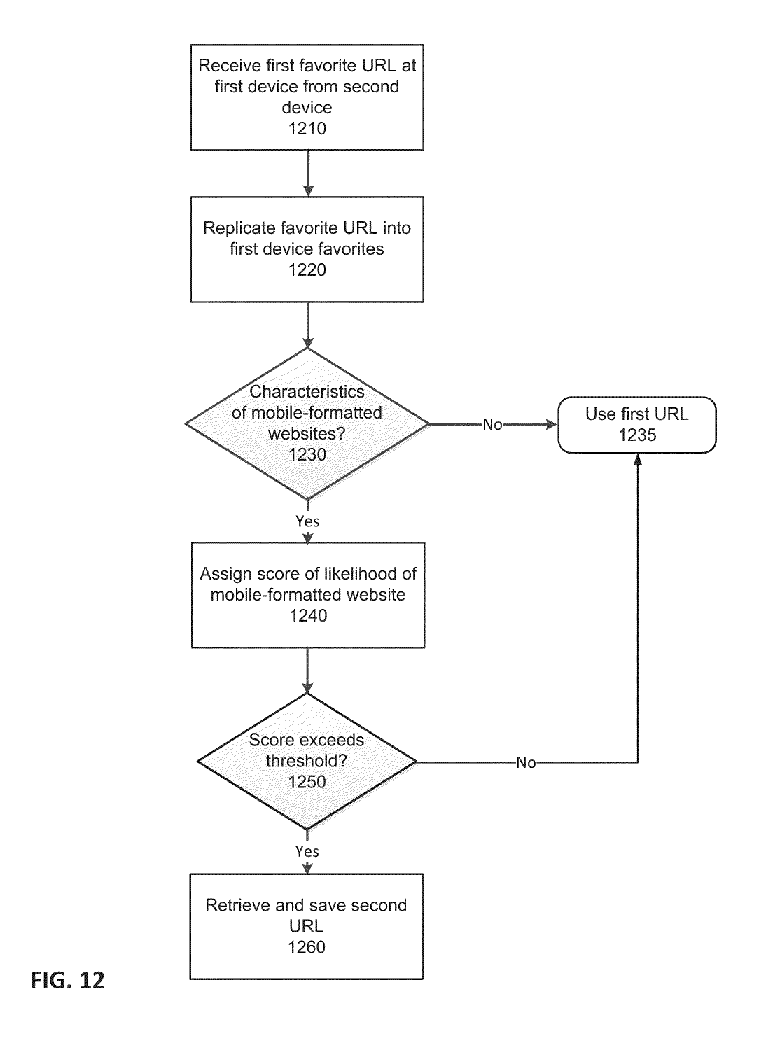

FIG. 12 is a flowchart for a method of sharing favorite webpages between mobile and non-mobile formatted devices, with reference to FIG. 5. The method begins with receiving 1210 at a first device an indication that a first URL for a webpage has been saved as first favorite webpage URL on a second device. For example, the URL may be saved locally on device 510 via history module 620 on browser 550a. In this example, the first and second devices are linked to a user account; the devices use different formats, e.g., the first device is a non-mobile enabled device and the second device is a mobile-enabled device. Devices 510 (mobile) and 520 (non-mobile) are exempla and are liked via user accounts 560 in a cloud server according to some embodiments. Next, the first URL for the webpage is replicated 1220 in the saved favorite webpages on the first device, for example, by sync module 610 on the browser and browser sync module 555 on the cloud server. The sync process allows information saved on one device (e.g., favorite webpages) to be synced with another device on the account such that both devices share the same collective information (e.g., the same stored list of favorite webpages). In other words, the favorite URL initially is identified and saved locally on device 510 via history module 620. Because devices 510, 520 are linked to each other via a shared account, e.g., via user accounts 560 of cloud server 520, the shared information is stored in the favorites 565 and synced between the two devices by browser sync module 555 (and corresponding sync module 610 on each of devices 510 and 520). The favorite URL thus is replicated into local storage on device 520, which is not a mobile-formatted device.

For example, on a mobile device (e.g., second device per the above), a user navigates to www.appleinsider.com. The site detects the user is on a mobile device and redirects to iphone.appleinsider.cotn in this example, the “first URL” would be iphone.appleinsider.com. However, in some cases sites can issue a mobile version without redirecting, done entirely through Javascript. In this scenario, the only difference is there would only be one URL from the mobile (second) device, e.g., m.nytimes.com.

Then the first URL and the webpage are examined to determine 1230 whether the first URL or webpage comprises one or more characteristics indicative of mobile-formatted webpages. For example, characteristics indicative of mobile-formatted webpages may comprise a URL with a mobile prefix (e.g., m.example.com), the webpage may have a fixed viewport with a width corresponding to a mobile device size class, or a webpage may display a smart app banner (e.g., display a control for launching a native application associated with the webpage). If the webpage does not have any characteristics of a mobile-formatted webpage, the first URL can be used 1235 by the non-mobile formatted device. This step is performed by site type module 650 in some embodiments.

However, if the first URL for the webpage does include at least one of the characteristics indicative of mobile-formatted websites, a score is assigned 1240 to the likelihood that the first URL for the website refers to a mobile-formatted version of the webpage. The likelihood may be based on one or more of the characteristics. For example, a mobile prefix (m.example.com) would receive a high score of likelihood of being a mobile-formatted webpage, which would not display well on a non-mobile formatted device such as device 520. In another example, if a webpage, had more than one characteristic, e.g., a fixed viewport of a small size class and a smart app banner, that webpage would receive a high likelihood score. The system may use a predetermined threshold score for determining likelihood that a webpage is mobile formatted, and the score for the webpage may be compared to that threshold. In response to the score for the first URL and/or its webpage exceeding a threshold score, a second URL for the webpage is retrieved 1260 and saved to the favorites. In the case where an m. prefix is used, the system may attempt to discern the non-mobile site URL by navigating to the site without its mobile prefix. For websites that issue a mobile version without redirecting, the same scoring rules would still apply. The second URL for the favorite webpage is stored in conjunction with the first URL for the website, e.g., on the first device 520. If the score does not exceed the threshold, then the first URL is used 1235 by the non-mobile enabled device.

A user may request to view the favorite webpage from various devices, including mobile-formatted (e.g., device 510) and non-mobile formatted devices (e.g., device 520). In response to a request for the favorite webpage in conjunction with the user account 560 via the first device, for example, the browser determines whether to access the page indicated b the first or second URL for the favorite webpage. For example, the determination may be based on whether the first device is formatted for display of the first URL for the favorite webpage (e.g., mobile device formatting if it is a mobile-formatted webpage). These steps ensure that mobile formatted webpages added on a mobile device don't render the mobile version of the page on non-mobile devices.

The need for distinguishing between a mobile webpage and a regular webpage may not just be for full webpages, but also for thumbnail images of pages. For example, in response to a request to switch to a thumbnail view of the favorite webpage, e.g., such as shown in FIG, 8C, determining whether to display a thumbnail of the page indicated by the first or second URL for the favorite webpage. Just as mobile-formatted webpages may not look very good displayed on a non-mobile formatted device, so too thumbnails of corresponding mobile-formatted pages also are not ideal for he thumbnail UI display, of FIG. 8C for example. Thus, the above process can be performed on webpages prior to the rendering of thumbnails in the UI 800′.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

Any of the steps, operations, or processes described herein may be performed or implemented with one or more hardware or software modules, alone or in combination with other devices. In some embodiments, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it tray not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method, comprising:
in response to opening a new tab or window in a browser, displaying a view comprising a first icons area, a concurrently displayed and visually distinguished second icons area, and a user interface element;
displaying in the first icons area a first plurality of icons, each of the first plurality of icons representing a webpage in a first category of webpages for a user of the browser, wherein a webpage is included in the first category based on the browser activity of the user;
identifying, for a second plurality of icons for display in the second icons area, which icons represent webpages in a second category of webpages for the user that are non-duplicates of the webpages in the first category of webpages, wherein a webpage is included in the second category in response to a user designation; concurrently displaying in the second icons area the identified non-duplicates of the first plurality of icons; and
wherein the user interface element comprises a control for replacing at least the second plurality of icons with a third plurality of icons, each of the third plurality of icons representing a website in a third category of webpages for the user, wherein a webpage is included in the third category based on a frequency and recency algorithm for the browser activity of the user.

2. The method of claim 1, further comprising displaying a webpage representation control, which when selected allows the user to switch between an icon view of the webpage comprising the first and second icons areas and a thumbnail view of the webpage comprising first and second thumbnail areas.

3. The method of claim 1, further comprising:
in response to receiving user input changing focus to a search bar of the browser, displaying a drop down menu comprising a list of the first category of webpages for a user of the browser; and
in response to receiving text input in the search bar, ceasing display of the drop down menu.

4. The method of claim 1, wherein in response to resizing of the webpage, the second plurality of icons the resized space in a different manner than the third plurality of icons.

5. The method of claim 1, wherein replacing at least the second plurality of icons with a third plurality of icons replaces the second plurality of icons in the second icons area with the third plurality of icons, and further comprising:
in response to selection of the control for replacing the second plurality of icons in the second icons area with the third plurality of icons:
identifying, for the third plurality of icons, which icons represent websites in the third category of websites for the user that are non-duplicates of the websites in the first category of websites; and
replacing the identified non-duplicates of the second plurality of icons displayed in the second icons area with the identified non-duplicates of the third plurality of icons.

6. The method of claim 5, wherein prior to identifying the non-duplicates of the second plurality of icons, determining the state of the control for whether to display the second plurality of icons or the third plurality of icons in the second icons area.

7. The method of claim 1, wherein replacing at least the second plurality of icons with a third plurality of icons replaces the first and second pluralities of icons with a view comprising the third plurality of icons.

8. The method of claim 7, wherein prior to identifying the non-duplicates of the second plurality of icons, determining the state of the control for whether to display the first and second pluralities of icons or the view comprising the third plurality of icons.

9. The method of claim 7, wherein in response to receiving user input to place focus in a search bar, displaying a drop down with a view displaying a miniature version of the view.

10. The method of claim 9, wherein the miniature version of the view has a width equal to a width of a search bar.

11. The method of claim 7, wherein the first icons area is displayed in an lower region of the view and the second icons area is displayed in an upper region on the view.

12. The method of claim 7, wherein:
the icons displayed in the view are touch icons specialized designed for display on touch-enabled devices; and
a device displaying the view is not a touch-enabled device.

13. The method of claim 7, further comprising replicating the first category of webpages from a device displaying the view to a device on a shared account.

14. A non-transitory computer readable storage medium storing executable instruction that when executed cause a data processing system to perform the following steps:
in response to opening a new tab or window in a browser, displaying a view comprising a first icons area, a concurrently displayed and visually distinguished second icons area, and a user interface element;
displaying in the first icons area a first plurality of icons, each of the first plurality of icons representing a webpage in a first category of webpages for a user of the browser, wherein a webpage is included in the first category based on the browser activity of the user;
identifying, for a second plurality of icons for display in the second icons area, which icons represent webpages in a second category of webpages for the user that are non-duplicates of the webpages in the first category of webpages, wherein a webpage is included in the second category in response to a user designation; concurrently displaying in the second icons area the identified non-duplicates of the first plurality of icons; and
wherein the user interface element comprises a control for replacing at least the second plurality of icons with a third plurality of icons, each of the third plurality of icons representing a website in a third category of webpages for the user, wherein a webpage is included in the third category based on a frequency and recency algorithm for the browser activity of the user.

15. The non-transitory computer readable storage medium of claim 14, further comprising displaying webpage representation control, which when selected allows the user to switch between an icon view of the webpage comprising the first and second icons areas and a thumbnail view of the webpage comprising first and second thumbnail areas.

16. The non-transitory computer readable storage medium of claim 14, wherein replacing at least the second plurality of icons with a third plurality of icons replaces the second plurality of icons in the second icons area with the third plurality of icons, and further comprising:
in response to selection of the control for replacing the second plurality of icons in the second icons area with the third plurality of icons:
identifying, for the third plurality of icons, which icons represent websites in the third category of websites for the user that are non-duplicates of the websites in the first category of websites; and
replacing the identified non-duplicates of the second plurality of icons displayed in the second icons area with the identified non-duplicates of the third plurality of icons.

17. The non-transitory computer readable storage medium of claim 14, wherein replacing at least the second plurality of icons with a third plurality of icons replaces the first and second pluralities of icons with a view comprising the third plurality of icons.

18. The non-transitory computer readable storage medium of claim 17, wherein prior to identifying the non-duplicates of the second plurality of icons, determining the state of the control for whether to display the first and second pluralities of icons or the view comprising the third plurality of icons.

19. The non-transitory computer readable storage medium of claim 17, wherein:
the icons displayed in the view are touch icons specialized designed for display on touch-enabled devices; and
a device displaying the view is not a touch-enabled device.

20. A device comprising:
means for displaying, in response to opening a new tab or window in a browser, a view comprising a first icons area, a concurrently displayed and visually distinguished second icons area, and a user interface element;
means for displaying in the first icons area a first plurality of icons, each of the first plurality of icons representing a webpage in a first category of webpages for a user of the browser, wherein a webpage is included ire the first category based on the browser activity of the user; and
means for identifying, for a second plurality of icons for display in the second icons area, which icons represent webpages in a second category of webpages for the user that are non-duplicates of the webpages in the first category of webpages, wherein a webpage is included in the second category in response to a user designation; concurrently displaying in the second icons area the identified non-duplicates of the first plurality of icons, wherein the user interface element comprises a control for replacing at least the second plurality of icons with a third plurality of icons, each of the third plurality of icons representing a website in a third category of webpages for the user, wherein a webpage is included in the third category based on a frequency and recency algorithm for the browser activity of the user.
